(19) United States
(12) Patent Application Publication
(10) Pub. No.: US 2020/0102817 A1
(43) Pub. Date: Apr. 2, 2020

(54) Pressure Signal Used to Determine Annulus Volume

(71) Applicant: Schlumberger Technology Corporation, Sugar Land, TX (US)

(72) Inventors: Yawan Couturier, Katy, TX (US); Jesse Hardt, Houston, TX (US); Paul Andrew Thow, Spring, TX (US)

(21) Appl. No.: 16/469,139

(22) PCT Filed: Dec. 8, 2017
(86) PCT No.: PCT/US2017/065206

§ 371 Date: Jun. 12, 2019

Related U.S. Application Data
(60) Provisional application No. 62/437,846, filed on Dec. 22, 2016.

(51) Int. Cl. E21B 47/00; E21B 47/06; G01F 22/02

(52) U.S. Cl. CPC E21B 47/0003; G01F 22/02; E21B 47/06

(57) ABSTRACT

A system for determining annulus fluid volume in a well bore during a drilling operation, the system having a pressure wave generator positioned at the top of a well, wherein the pressure wave generator generates a pressure wave that propagates through the annulus fluid in the well; a first pressure wave receiver positioned in the annulus of the well to receive the generated pressure wave at a first time value; a second pressure wave receiver positioned in the annulus of the well to receive the generated pressure wave at a second time value; and a controller that determines a change in annulus fluid volume based at least in part on a phase shift between the received pressure wave at the first and second time values.

### BACKGROUND

The present document is based on and claims priority to U.S. Provisional Application Ser. No.: 62/437,846, filed Dec. 22, 2016, which is incorporated herein by reference in its entirety.

As described in US Publication Number 2016/0138350, incorporated by reference in its entirety, the drilling of a borehole is typically carried out using a steel pipe known as a drillstring with a drill bit coupled on the lower most end of the drillstring. The entire drillstring may be rotated using an over-ground drilling motor, or the drill bit may be rotated independently of the drillstring using a fluid powered motor or motors mounted in the drillstring just above the drill bit. As drilling progresses, a flow of drilling fluid is used to carry the debris created by the drilling process out of the borehole. The drilling fluid is pumped through an inlet line down the drillstring to pass through the drill bit, and returns to the surface via an annular space between the outer diameter of the drillstring and the borehole (generally referred to as the annulus or the drilling annulus).

Drilling fluid is a broad drilling term that may cover various different types of drilling fluids. The term “drilling fluid” may be used to describe any fluid or fluid mixture used during drilling and may cover such things as air, nitrogen, misted fluids in air or nitrogen, foamed fluids with air or nitrogen, aerated or nitrified fluids to heavily weighted mixtures of oil or water with solid particles.

The drilling fluid flow through the drillstring may be used to cool the drill bit. In conventional overbalanced drilling, the density of the drilling fluid is selected so that it produces a pressure at the bottom of the borehole (the “bottom hole pressure” or “BHP”), which is high enough to counter-balance the pressure of fluids in the formation (the “formation pore pressure”). By counter-balancing the pore pressure, the BHP acts to prevent the inflow of fluids from the formations surrounding the borehole. However, if the BHP falls below the formation pore pressure, formation fluids, such as gas, oil and/or water may enter the borehole and produce what is known in drilling as a kick. By contrast, if the BHP is very high, the BHP may be higher than the fracture strength of the formation surrounding the borehole resulting in fracturing of the formation. When the formation is fractured, the drilling fluid-which is circulated down the drillstring and through the borehole, for among other things, removing drilling cuttings from the bottom of the borehole-may enter the formation and be lost from the drilling process. This loss of drilling fluid from the drilling process may cause a reduction in BHP and as a consequence cause a kick as the BHP falls below the formation pore pressure.

In order to overcome the problems of kicks and/or fracturing of formations during drilling, a process known as managed pressure drilling (“MPD”) has been developed. The International Association of Drilling Contractors (IADC) defines Managed Pressure Drilling (MPD) as “an adaptive drilling process used to more precisely control the annular pressure profile throughout a wellbore.” In MPD various techniques may be used to control the BHP during the drilling process. One such method comprises injecting gas into the drilling fluid/mud column in the drilling annulus (during the drilling process drilling fluid/mud is continuously circulated down the drillstring and back up through the annulus formed between the drillstring and the wall of the borehole being drilled and, as a result, during the drilling process a column of drilling fluid/mud is present in the annulus) to reduce the BHP produced by the column of the mud/drilling fluid in the drilling annulus.

In MPD, the annulus may be closed using a pressure containment device. This device comprises sealing elements, which engage with the outside surface of the drillstring so that flow of fluid between the sealing elements and the drillstring is substantially prevented. The sealing elements may allow for rotation of the drillstring in the borehole so that the drill bit on the lower end of the drillstring may be rotated. A flow control device may be used to provide a flow path for the escape of drilling fluid from the annulus. After the flow control device, a pressure control manifold, with at least one adjustable choke, valve and/or the like, may be used to control the rate of flow of drilling fluid out of the annulus. When closed during drilling, the pressure containment device creates a backpressure in the borehole, and this back pressure can be controlled by using the adjustable choke or valve on the pressure control manifold to control the degree to which flow of drilling fluid out of the annulus/riser annulus is restricted.

During MPD an operator may monitor and compare the flow rate of drilling fluid into the drillstring with the flow rate of drilling fluid out of the annulus to detect if there has been a kick or if drilling fluid is being lost to the formation. A sudden increase in the volume or volume flow rate out of the annulus relative to the volume or volume flow rate into the drillstring may indicate that there has been a kick. By contrast, a sudden drop in the flow rate out of the annulus/relative to the flow rate into the drillstring may indicate that the drilling fluid has penetrated the formation and is being lost to the formation during the drilling process.

Prior MPD systems estimate the change in annulus volume by using the initial volume of the annulus, length of the drill string and the pressure signal from the choke. However, merely estimating the annulus volume may lead to inaccuracies and introduce lag time between flow rate modifications made at the surface and actual pressure fluctuations downhole.

There is a need for MPD systems that more accurately determine annulus volume.

### SUMMARY

In accordance with the teachings of the present disclosure, disadvantages and problems associated with existing MPD systems have been reduced.

An aspect of the invention provides a system for determining annulus fluid volume in a well, the system having a pressure wave generator positioned at the top of a well, wherein the pressure wave generator generates a pressure wave that propagates through the annulus fluid in the well; a first pressure wave receiver positioned in annulus of the well to receive the generated pressure wave at a first time value; a second pressure wave receiver positioned in the well in annulus of the well to receive the generated pressure wave at a second time value; and a controller that determines a change in annulus fluid volume based at least in part on a phase shift between the received pressure wave at the first and second time values.

According to a further aspect of the invention, there is provided a method for determining annulus fluid volume in a well, the method having steps of: generating a pressure wave in the top of an annulus defined between a drill string exterior and the interior of a well bore, wherein the pressure wave propagates through annulus fluid in the well; receiving at a first time value the pressure wave via a first pressure wave receiver positioned in the annulus of the well; receiving at a second time value the pressure wave via a second pressure wave receiver positioned in the annulus of the well; and determining a change in annulus fluid volume based at least in part on a phase shift between the received pressure wave at the first and second time values.

Still another aspect of the invention provides a system for determining annulus fluid volume in a well, the system comprising: a pressure wave generator positioned at the top of a well, wherein the pressure wave generator generates a pressure wave that propagates through the annulus fluid in the well; a first pressure wave receiver positioned in annulus of the well to receive the generated pressure wave at a first time value; a second pressure wave receiver positioned in the well in annulus of the well to receive the generated pressure wave at a second time value; a processor; a non-transitory storage medium; and a set of computer readable instructions stored in the non-transitory storage medium, wherein when the instructions are executed by the processor allow the controller to: measure a phase shift between the pressure wave at first and second time values; and calculate a bulk modulus of fluid in the annulus from a propagation velocity and a constant or measured fluid density.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 is a schematic side view of a drilling rig over a well bore, wherein surface instrumentation determines changes in annulus fluid volume during a drilling process.

FIG. 2 illustrates a detailed view of a bottom hole assembly shown in FIG. 1, wherein the BHA has two pressure transducer/receivers for converting a pressure wave to electrical signals so a phase shift may be determined.

FIG. 3 shows a flow diagram for a process of regulating annulus fluid volume in a well bore during a drilling operation.

### DETAILED DESCRIPTION

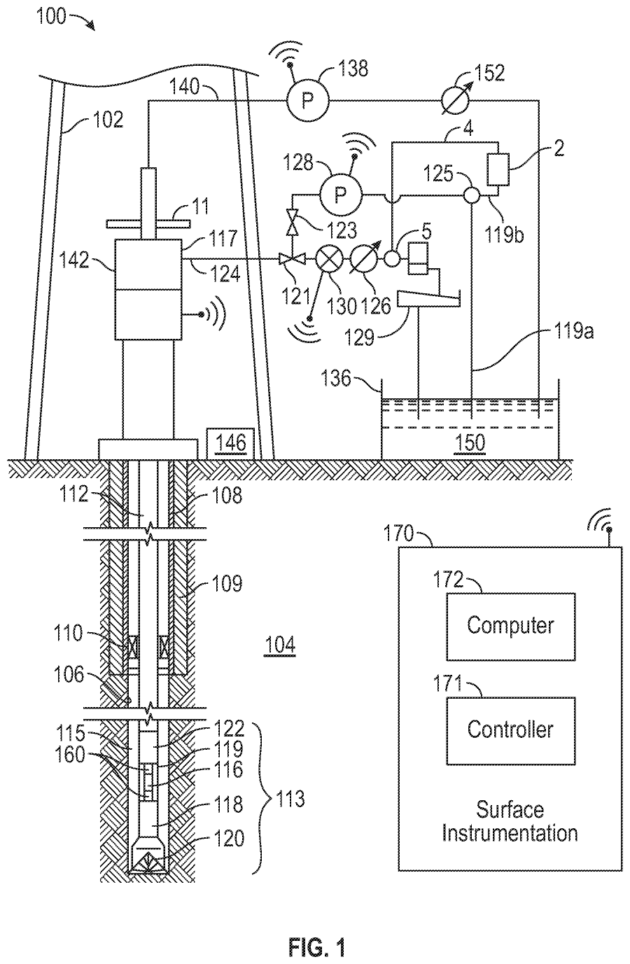

Preferred embodiments are best understood by reference to FIGS. 1-3 below in view of the following general discussion. The present disclosure may be more easily understood in the context of a high level description of certain embodiments.

According to certain aspects of the invention, annulus volume is determined by measuring the propagation velocity of a pressure pulse in the annulus fluid, wherein the pressure pulse propagates between the surface and the bottom of the hole. Pressure pulses may be created using the control choke, rig pump or drill string, which are then received by the Pressure While Drilling (PWD) Tool. The measured phase shift between pressure pulses provides a transit time from surface to the bit which gives the propagation velocity of a pressure wave. The propagation velocity, coupled with a constant or measured fluid density, may be used to calculate the bulk modulus of the drilling fluid. The bulk modulus of the fluid would then be used to calculate the change in annulus volume by using the initial volume of the annulus, length of the drill string and the pressure signal from the choke.

The measurement of the bulk modulus could also be achieved by placing pressure sensors at the surface or along the drill pipe. The pressure sensors would be used to measure the velocity of the pressure wave produced by the control choke, rig pump or by surging the drill string. Any of these methods could be used to create a pressure pulse, which would provide the wave velocity and thus allow the same calculations to be made for annulus volume. This process would be used to calculate an approximate volume within the annulus and create a data trend that could be used to determine whether the annulus volume was increasing or decreasing.

The process of estimating the volume would allow the detection of an influx based upon increasing volume in the annulus. This process would give a real time trend line of the estimated change in annulus volume which would provide valuable information that could be used to determine if the well was flowing and even if the well is experiencing losses. Furthermore, the calculations could be used to determine hole depth, and given the input of other variables could potentially be used to estimate the size of an influx and its approximate location in the wellbore.

FIG. 1 is a plan view of a drilling system having a dynamic annular pressure control (DAPC) system disclosed in U.S. Pat. No. 8,757,272, incorporated herein in its entirety. It will be appreciated that either a land based or an offshore drilling system may have a DAPC system as shown in FIG. 1, and the land based system shown in FIG. 1 is not a limitation on the scope of the invention. The drilling system 100 is shown including a drilling rig 102 that is used to support drilling operations. Certain components used on the drilling rig 102, such as the kelly, power tongs, slips, draw works and other equipment are not shown separately in the Figures for clarity of the illustration. The rig 102 is used to support a drill string 112 used for drilling a wellbore through Earth formations such as shown as formation 104. As shown in FIG. 1 the wellbore 106 has already been partially drilled, and a protective pipe or casing 108 set and cemented 109 into place in the previously drilled portion of the wellbore 106. In the present example, a casing shutoff mechanism, or downhole deployment valve, 110 may be installed in the casing 108 to shut off the annulus and effectively act as a valve to shut off the open hole section of the wellbore 106 (the portion of the wellbore 106 below the bottom of the casing 108) when a drill bit 120 is located above the valve 110.

The drill string 112 supports a bottom hole assembly (BHA) 113 that may include the drill bit 120, an optional hydraulically powered (“mud”) motor 118, an optional measurement- and logging-while-drilling (MWD/LWD) sensor system 119 that preferably includes a pressure transducer 116 to determine the annular pressure in the wellbore 106. The sensor system 119 may also be a Pressure While Drilling (PWD) Tool. The drill string 112 may include a check valve (not shown) to prevent backflow of fluid from the annulus into the interior of the drill string 112 should there be pressure at the surface of the wellbore. The MWD/LWD suite 119 preferably includes a telemetry system 122 that is used to transmit pressure data, MWD/LWD sensor data, as well as drilling information to the Earth's surface. The sensor system 119 may also include two receivers 160 that are spaced apart. As shown in FIG. 1, the receivers are positioned above and below the pressure transducer 116. While FIG. 1 illustrates a BHA using a mud pressure modulation telemetry system, it will be appreciated that other telemetry systems, such as radio frequency (RF), electromagnetic (EM) or drill string transmission systems may be used with the present invention.

The drilling process requires the use of drilling fluid 150, which is typically stored in a tank, pit or other type of reservoir 136. The reservoir 136 is in fluid communications with one or more rig mud pumps 138 which pump the drilling fluid 150 through a conduit 140. The conduit 140 is hydraulically connected to the uppermost segment or “joint” of the drill string 112 (using a swivel in a kelly or top drive). The drill string 112 passes through a rotating control head or “rotating BOP” 142. The rotating BOP 142, when activated, forces spherically shaped elastomeric sealing elements to rotate upwardly, closing around the drill string 112 and isolating the fluid pressure in the wellbore annulus, but still enabling drill string rotation and longitudinal movement. Commercially available rotating BOPs, such as those manufactured by National Oilwell Varco, 10000 Richmond Avenue, Houston, Tex. 77042 are capable of isolating annulus pressures up to 10,000 psi (68947.6 kPa). The fluid 150 is pumped down through an interior passage in the drill string 112 and the BHA 113 and exits through nozzles or jets (not shown separately) in the drill bit 120, whereupon the fluid 150 circulates drill cuttings away from the bit 120 and returns the cuttings upwardly through the annular space 115 between the drill string 112 and the wellbore 106 and through the annular space formed between the casing 108 and the drill string 112. The fluid 150 ultimately returns to the Earth's surface and is diverted by the rotating BOP 142 through a diverter 117, through a conduit 124 and various surge tanks and telemetry receiver systems (not shown separately).

Thereafter the fluid 150 proceeds to what is generally referred to herein as a backpressure system which may consist of a choke 130, valve 123 and pump pipes and optional pump as shown at 128. The fluid 150 enters the backpressure system 131 and may flow through an optional flow meter 126.

The returning fluid 150 proceeds to a wear resistant, controllable orifice choke 130. It will be appreciated that there exist chokes designed to operate in an environment where the drilling fluid 150 contains substantial drill cuttings and other solids. Choke 130 may be capable of operating at variable pressures, variable openings or apertures, and through multiple duty cycles. Position of the choke 130 may be controlled by an actuator, which may be a hydraulic cylinder/piston combination.

The fluid 150 exits the choke 130 and flows through a valve 121. The fluid 150 can then be processed by an optional degasser and by a series of filters and shaker table 129, designed to remove contaminants, including drill cuttings, from the fluid 150. The fluid 150 is then returned to the reservoir 136. A flow loop 119A is provided in advance of a three-way valve 125 for conducting fluid 150 directly to the inlet of the backpressure pump 128. Alternatively, the backpressure pump 128 inlet may be provided with fluid from the reservoir 136 through conduit 119B, which is in fluid communication with the trip tank (not shown). The trip tank (not shown) is normally used on a drilling rig to monitor drilling fluid gains and losses during pipe tripping operations (withdrawing and inserting the full drill string or substantial subset thereof from the wellbore). The three-way valve 125 may be used to select loop 119A, conduit 119B or to isolate the backpressure system. While the backpressure pump 128 is capable of utilizing returned fluid to create a backpressure by selection of flow loop 119A, it will be appreciated that the returned fluid could have contaminants that would not have been removed by filter/shaker table 129. In such case, the wear on backpressure pump 128 may be increased. Therefore, the preferred fluid supply for the backpressure pump 128 is conduit 119A to provide reconditioned fluid to the inlet of the backpressure pump 128.

In operation, the three-way valve 125 would select either conduit 119A or conduit 119B, and the backpressure pump 128 may be engaged to ensure sufficient flow passes through the upstream side of the choke 130 to be able to maintain backpressure in the annulus 115, even when there is no drilling fluid flow coming from the annulus 115. In the present embodiment, the backpressure pump 128 is capable of providing up to approximately 2200 psi (15168.5 kPa) of pressure; though higher pressure capability pumps may be selected at the discretion of the system designer.

The system can include a flow meter 152 in conduit 100 to measure the amount of fluid being pumped into the annulus 115. It will be appreciated that by monitoring flow meters 126, 152 and thus the volume pumped by the backpressure pump 128, it is possible to determine the amount of fluid 150 being lost to the formation, or conversely, the amount of formation fluid entering to the wellbore 106. Further included in the system is a provision for monitoring wellbore pressure conditions and predicting wellbore 106 and annulus 115 pressure characteristics.

Pressure pulses may be created using the controllable orifice choke 130, the rig mud pump 138, or the drill string 112. The pressure pulses may be received by a Pressure While Drilling (PWD) Tool, or two pressure transducer/receivers 160. The measured phase shift between pressure pulses provides a transit time from surface to the bit which gives the propagation velocity of a pressure wave. The propagation velocity, coupled with a constant or measured fluid density, may be used to calculate the bulk modulus of the drilling fluid. The bulk modulus of the fluid may then be used to calculate the change in annulus volume by using the initial volume of the annulus, length of the drill string 112 and the pressure signal from the controllable orifice choke 130.

Referring again to FIG. 1, pressure waves detected by the two pressure transducer/receivers 160 may be converted to pressure wave signals and transmitted to surface instrumentation 170. The surface instrumentation 170 may comprise computer 172 and controller 171. Hardware/software modules may be incorporated into the surface instrumentation 170 to calculate the bulk modulus and the annulus volume.

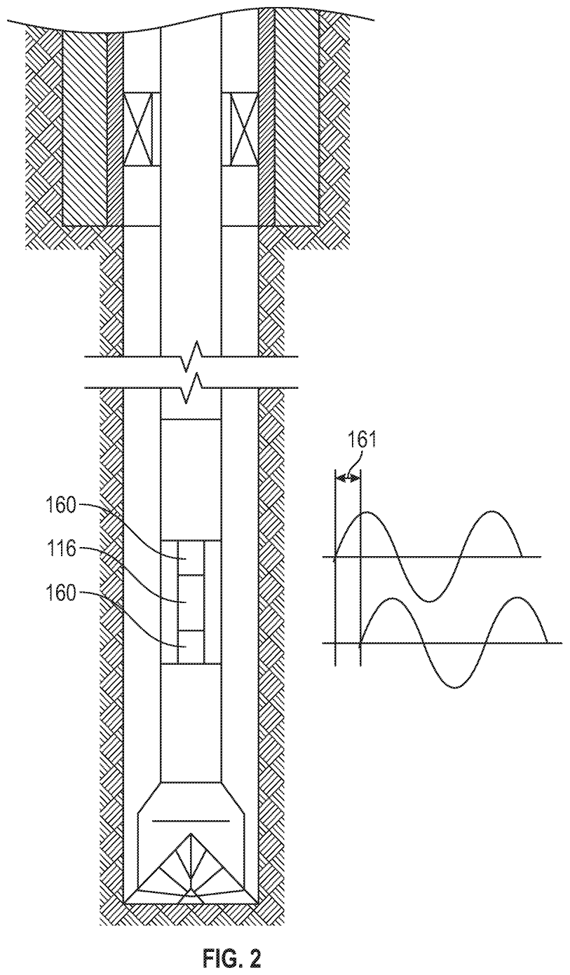

FIG. 2 illustrates in greater detail a side view of the bottom hole assembly of FIG. 1. The two pressure transducer/receivers 160 are positioned in the bottom hole assembly separate from each other so that they will receive the pressure wave at different times as the pressure wave travels down the annulus. A sine wave is shown adjacent to each pressure transducer/receiver 160 to represent reception of the pressure wave. The difference in time between when each of the pressure transducer/receivers 160 receives the pressure wave is a phase shift 161. The two pressure transducer/receivers 160 may be coupled to electronic circuitry disposed inside the sensor system 119 to measure the phase shift 161 of the pressure wave between the two pressure transducer/receivers 160.

In some examples, more than one transducer/receivers may be used to measure phase shift between the receivers. More than one wave frequency may be observed, wherein different frequencies may provide different raw values of phase difference and magnitude of the spikes associated with pressure waves. However, the general appearance of the phase difference curve at sensor system 119 may be substantially similar. Such appearance similarity may be used with reference to different transducer/receivers spacings to confirm that the changes in phase shift actually correspond to the pressure wave and not some other physical attribute of the drill string or annulus, such as change in annulus diameter, etc.

By properly scaling the raw phase response on a log chart the measured velocity of the pressure wave can be identified. Scaling the phase difference response may be performed by using measurements transmitted to the surface from the sensor system 119, or may be made by using measurements recorded in the tools with respect to time, and correlating the time indexed recorded measurements to a time record made at the surface in a control unit.

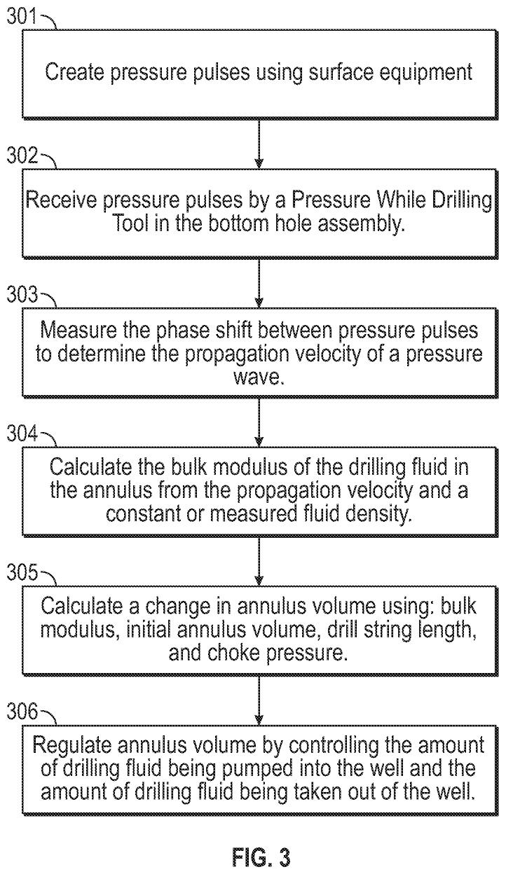

FIG. 3 illustrates a process for regulating annulus fluid volume. Pressure pulses are created 301 using surface equipment. The pressure pulses are received 302 by a Pressure While Drilling Tool in the bottom hole assembly. A phase shift between pressure pulses is measured 303 to determine the propagation velocity of a pressure wave in the annulus fluid. The bulk modulus of the drilling fluid in the annulus is calculated 304 from the propagation velocity and a constant or measured fluid density. A change in the annulus volume is calculated 305 using the bulk modulus, the initial annulus volume, the drill sting length and a choke pressure. The annulus fluid volume may then be regulated 306 by controlling the amount of drilling fluid being pumped into the well and the amount of drilling fluid being returned or taken out of the well.

Although the disclosed embodiments are described in detail in the present disclosure, it should be understood that various changes, substitutions and alterations can be made to the embodiments without departing from their spirit and scope.

What is claimed is:

1. A system for determining annulus fluid volume in a well, the system comprising:
a pressure wave generator positioned at the top of a well, wherein the pressure wave generator generates a pressure wave that propagates through the annulus fluid in the well;
a first pressure wave receiver positioned in the annulus of the well to receive the generated pressure wave at a first time value;
a second pressure wave receiver positioned in the annulus of the well to receive the generated pressure wave at a second time value; and
a controller that determines a change in annulus fluid volume based at least in part on a phase shift between the received pressure wave at the first and second time values.

2. A system for determining annulus fluid volume as claimed in claim 1, wherein the pressure wave generator comprises a controllable orifice choke.

3. A system for determining annulus fluid volume as claimed in claim 1, wherein the pressure wave generator comprises a rig mud pump.

4. A system for determining annulus fluid volume as claimed in claim 1, wherein the pressure wave generator comprises the drill string.

5. A system for determining annulus fluid volume as claimed in claim 1, wherein the first pressure wave receiver comprises a pressure while drilling tool.

6. A system for determining annulus fluid volume as claimed in claim 1, wherein the second pressure wave receiver comprises a pressure while drilling tool.

7. A system for determining annulus fluid volume as claimed in claim 1, wherein the controller comprises:
a processor;
a non-transitory storage medium; and
a set of computer readable instructions stored in the non-transitory storage medium,
wherein when the instructions are executed by the processor allow the controller to:
measure a phase shift between the pressure wave at first and second time values; and
calculate a bulk modulus of fluid in the annulus from a propagation velocity and a constant or measured fluid density.

8. A system for determining annulus fluid volume as claimed in claim 7, wherein the set of computer readable instructions further comprises instructions when executed by the processor allow the controller to calculate a change in annulus volume using: bulk modulus, initial annulus volume, drill string length and choke pressure.

9. A system for determining annulus fluid volume as claimed in claim 1, further comprising a regulator of annulus volume that controls the amount of drilling fluid being pumped into the well and the amount of drilling fluid being taken out of the well.

10. A system for determining annulus fluid volume as claimed in claim 1, further comprising a mud pump that pumps fluid into a drill string positioned in the well to define the annulus between the exterior of the drill string and the interior of the well bore, and a controllable orifice choke that regulates drilling fluid flowing from the annulus.

11. A method for determining annulus fluid volume in a well, the method comprising:
generating a pressure wave in the top of an annulus defined between a drill string exterior and the interior of a well bore, wherein the pressure wave propagates through annulus fluid in the well;
receiving at a first time value the pressure wave via a first pressure wave receiver positioned in the annulus of the well;
receiving at a second time value the pressure wave via a second pressure wave receiver positioned in the annulus of the well; and
determining a change in annulus fluid volume based at least in part on a phase shift between the received pressure wave at the first and second time values.

12. A method for determining annulus fluid volume as claimed in claim 11, wherein the generating a pressure wave comprises manipulating a controllable orifice choke.

13. A method for determining annulus fluid volume as claimed in claim 11, wherein the generating a pressure wave comprises manipulating a rig mud pump.

14. A method for determining annulus fluid volume as claimed in claim 11, wherein the generating a pressure wave comprises manipulating the drill string.

15. A method for determining annulus fluid volume as claimed in claim 11, wherein the receiving at a first time value the pressure wave comprises converting the pressure wave to an electrical signal.

16. A method for determining annulus fluid volume as claimed in claim 11, wherein the receiving at a second time value the pressure wave comprises converting the pressure wave to an electrical signal.

17. A method for determining annulus fluid volume as claimed in claim 11, wherein the determining a change in annulus fluid volume comprises calculating a bulk modulus of fluid in the annulus from a propagation velocity and a constant or measured fluid density.

18. A method for determining annulus fluid volume as claimed in claim 11, wherein the determining a change in annulus fluid volume comprises calculating the change in annulus fluid volume based at least in part on a bulk modulus, an initial annulus volume a drill string length and a choke pressure.

19. A system for determining annulus fluid volume in a well, the system comprising:
a pressure wave generator positioned at the top of a well, wherein the pressure wave generator generates a pressure wave that propagates through the annulus fluid in the well;
a first pressure wave receiver positioned in annulus of the well to receive the generated pressure wave at a first time value;
a second pressure wave receiver positioned in the well in annulus of the well to receive the generated pressure wave at a second time value;
a processor;
a non-transitory storage medium; and
a set of computer readable instructions stored in the non-transitory storage medium,
wherein when the instructions are executed by the processor allow the controller to:
measure a phase shift between the pressure wave at first and second time values; and
calculate a bulk modulus of fluid in the annulus from a propagation velocity and a constant or measured fluid density.

20. A system for determining annulus fluid volume as claimed in claim 19, wherein the set of computer readable instructions further comprises instructions when executed by the processor allow the controller to calculate a change in annulus volume using: bulk modulus, initial annulus volume, drill string length and choke pressure.
